(19) United States
(12) Patent Application Publication
(10) Pub. No.: US 2010/0091617 A1
(43) Pub. Date: Apr. 15, 2010

(54) TIMEPIECE GEAR TRAIN

(75) Inventors: Eric Goeller, Les Hopitaux Vieux (FR); Vincent Calabrese, Lausanne (CH)

Correspondence Address: GRIFFIN & SZIPL, PC, SUITE PH-1, 2300 NINTH STREET, SOUTH, ARLINGTON, VA, 22204, US

(73) Assignees: MONTRES BREGUET S.A., L'Abbaye (CH); BLANCPAIN S.A., Le Brassus (CH)

(21) Appl. No.: 12/572,799

(22) Filed: Oct. 2, 2009

(30) Foreign Application Priority Data
Oct. 2, 2008 (EP) 08165751.2

(51) Int. Cl. G04B 19/02; G04B 15/00

(52) U.S. Cl. 368/127; 368/220

(57) ABSTRACT

The invention concerns a timepiece gear train including at least one pair of circular toothed elements (25, 31) with parallel axes, the elements being provided with respectively toothings that are meshed with each other so that one (25) of the elements drives the other. In order to improve transmission conditions within the gear without reducing the toothing module, the corresponding toothings of each of the two elements are multiple, each of them being formed of N coaxial, toothed rings (28a, 28b; 30a, 30b) angularly shifted relative to each other by a fraction of a pitch of the toothing. In the simplest version, each of the toothings is double (N=2), the two rings being angularly shifted by a half-pitch. The invention prevents gearing in areas located relatively far from the line connecting the centres of the toothed elements, thus reducing torque and velocity variations during the lead of a tooth. Applications are envisaged in particular in a going train, a display train and a rotating escapement, such as a tourbillon.

### BACKGROUND OF THE INVENTION

The present invention concerns a timepiece gear train including at least one pair of circular, toothed elements, with parallel axes, wherein the toothed elements are provided with respective toothings that mesh with each other. The invention applies in particular to pairs of rotating wheel sets of the going train, which connects the drive motor of a mechanical timepiece movement to the regulating member, in particular to the escape wheel set thereof. However, the invention may find other applications in watch making, for example in a display train.

In gears in general and in a gear with straight teeth in particular, the point of contact between the combined profiles of the flanks of the two teeth that are touching moves radially during the arc of action or lead of a tooth, by rising towards the head of the driving tooth. This phenomenon is illustrated schematically in the annexed FIG. 1, which shows the gearing of a driving wheel 10 with eighty-two teeth and a primitive radius R1 with a driven wheel 11 with twelve teeth and a primitive radius R2, with the arrow indicating the direction of rotation. The geometrical place of the points of contact, called the path of contact 12 (or line of gear action), extends from point A to point B and passes through the two pitch-circles of the toothings in proximity to the centre line 13 that connects the centres of the two wheels. As a result, during the lead of a tooth, the torque ratio (represented by curve 14 opposite the central vertical scale) varies, as does the velocity ratio. It will easily be understood that the variation in distance at the centre between A and B is proportionally much greater on wheel 11 of small radius than on wheel 10, such that a constant torque on wheel 10 will produce a markedly variable torque on wheel 11. Moreover, the transmission yield also varies, generally being poorer when the point of contact is far away from the centre line. If, in addition, the profile has irregularities there, the resulting transmission defects are more pronounced in the central area of the path of contact.

In the going train of a timepiece movement, in particular on the wheel sets close to the motor member, the gear modules must be relatively large because of high forces, and consequently so must the angular pitch. For the reasons mentioned above, the transmission regularity of a gear with a large module is considerably poorer than that of a small module gear with a large number of teeth. Moreover, the low speed of the upstream part of the going train amplifies the effect of this defect on isochronism.

Variation in torque during a tooth lead is a defect, but so is variation in angular velocity. For example, in a display train, the passing of a tooth is accompanied by a variation in the velocity of a display hand and this variation may be considerable if the gear concerned is slow. Moreover, the display train modules are often large, because pivots are less precise than in a going train, and this leads to the aforementioned drawbacks.

For various manufacturing and assembly reasons, the presence of a relatively large clearance (or circumferential play) in timepiece gears is an aggravating factor, since it leads to an increase in the size of the module. Another peculiarity of timepiece gears is that, because of the small size of the elements, centring precision and precision as to the shape of the teeth are not always as good as in other mechanisms.

In order to reduce the aforecited drawbacks, CH Patent No. 244641 proposes correcting the teeth profiles, by moving away from the normal profile to an involute profile so as to make the value of the force transmitted from one tooth to another more uniform. Other solutions consisting in correcting the teeth profiles are mentioned in CH Patent No. 318895, However, they do not avoid the main unfavourable condition, namely that the further the path of contact extends away from the centre line, the more some parts of the line move away from the pitch-circles, as is the case in proximity to points A and B in FIG. 1.

Theoretically, it would be possible to reduce the length of path of contact 12 by increasing the number of teeth, thereby reducing the module and pitch of the toothing. However, this would result in a decrease in the thickness of the teeth which is unacceptable, particular in the slow and greatly stressed part of the going train of a mechanical timepiece movement. Moreover, such an increase in the wheel sets that already have a large number of teeth would make it very difficult, if not impossible, to machine the toothing.

### SUMMARY OF THE INVENTION

It is an object of the present invention to improve a timepiece gear train so as to substantially overcome the aforementioned drawbacks of the gears usually used in this field, by making transmission of torque and/or velocity more uniform, without weakening the teeth and excessively complicating manufacture and assembly.

There is therefore provided a timepiece train of the type indicated in the above preamble, characterized in that said toothings of each of the two toothed elements are multiple, each of them being formed of N coaxial toothed rings, shifted angularly in relation to each other by a fraction of a pitch of the toothing. In most applications, it is enough for each of the toothings of the two toothed elements to be double (N=2), with the two rings being angularly shifted by a half-pitch, but the use of triple toothings shifted by one third of a pitch could also be envisaged in some cases, for example in large timepieces.

Because of this arrangement, the N toothed rings of each toothing act one after the other. For the same toothing module, the length of the path of contact is divided by N and this path remains confined in proximity to the centre line, i.e. in the area where it is easier for the profile of each tooth to be optimal and where the gear conditions are most favourable, in particular while exhibiting a low radii variation during a tooth lead. As a result, the torque and velocity ratios are much more uniform than with simple toothings, even with the tooth profiles usually used in watch making. By preventing contact between teeth in areas far from the centre line, where the profile is not optimum and hertzians pressures are higher, the gear has a better yield and is less subject to wear. Thus, the advantages of large module toothings are combined with those of toothings with a large number of teeth, while avoiding, to a great extent, their specific drawbacks. Moreover, the additional manufacturing cost is limited to multiplying some elements, without making them more difficult to manufacture.

Other features and advantages of the invention will appear more clearly below in the description of two advantageous embodiments, given by way of non-limiting examples with reference to the annexed drawings.

### BRIEF DESCRIPTION OF THE DRAWINGS

FIG. 1 shows schematically the gearing of two conventional timepiece wheels with straight teeth.

FIG. 2 is a schematic perspective view showing a first embodiment of the invention on one part of the going train of a watch, seen from the barrel.

FIG. 3 is a schematic plan view of the subject of FIG. 2.

FIG. 4 is an enlarged view of detail IV of FIG. 3.

FIG. 5 is a cross-section along the line V-V of FIG. 3.

FIG. 6 is a partial bottom view of a watch tourbillon, showing a second embodiment of the invention.

FIG. 7 is an enlarged view of one part of FIG. 6.

### DETAILED DESCRIPTION OF EMBODIMENTS OF THE INVENTION

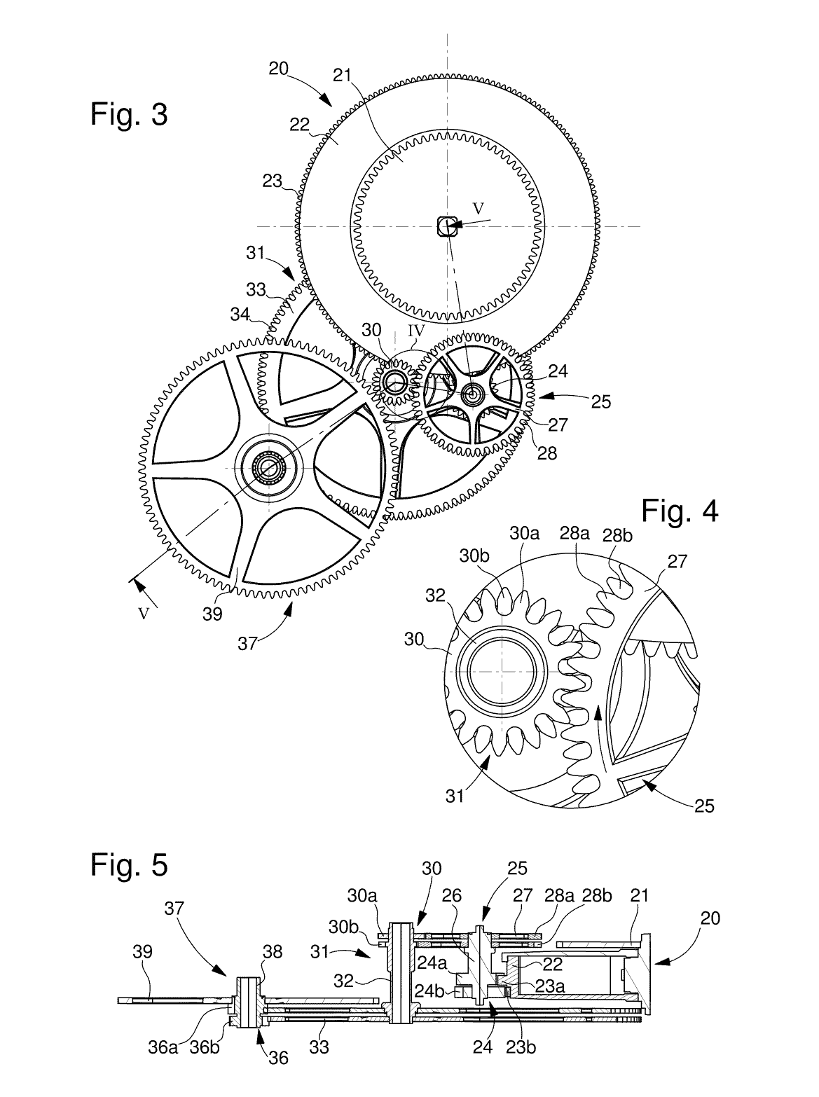

FIGS. 2 to 5 show the barrel spring 20 of a watch movement, including a ratchet 21 and a rotating drum 22 whose peripheral wall is fitted with a straight toothing 23 that meshes on a pinion 24 of an intermediate wheel set 25. Wheel set 25 also has an arbour 26 and an intermediate wheel 27. Toothing 28 of the intermediate wheel meshes on a pinion 30 of a centre wheel set 31 that further includes a tubular arbour 32 and a centre wheel 33. Toothing 34 of the centre wheel meshes on a pinion 36 of a third wheel set 37 that further includes a tubular arbour 38 and third wheel 39, which is omitted from FIG. 2 to make the drawing more clear. These wheel sets form the upstream part of the going train of the watch, the downstream part of which transmits the movement of the third wheel 39 to the regulating member. In order to make the drawings clear, the elements that support the rotating wheel sets described have not been shown.

According to the principle of the invention explained above, each of driving toothings 23, 28 and 34 and the toothings of the driven pinions 24, 30 and 36 is double: it is formed of two coaxial and superposed toothed rings 23a, and 23b, 24a and 24b, 28a and 28b, 30a and 30b, 34a and 34b, 36a and 36b. The teeth of the two rings of one toothing are identical, but those of the second ring are shifted angularly by a half-pitch of the toothing relative to those of the second ring. Thus, as seen in plan in FIG. 4, each tooth of the top toothing 27a of wheel 27 is located exactly midway between two teeth of the bottom toothing 27b, and each tooth of the top toothing 30a of pinion 30 is located exactly midway between two teeth of the bottom toothing 30b of that pinion. For the sake of simplicity, this toothing will be called “duplex” in the following description.

In the example of FIGS. 2 to 5, the inventor considers that the extra design costs resulting from duplex toothings is only justified for the slowest wheel sets of the gear train, where the forces are large, which is why this solution is not applied to the third wheel 39 or upstream, where the aforecited variations are smoothed out because of the rapidity of rotation. One could even envisage, in a less expensive embodiment, limiting the use of duplex toothings to the first gear stage, i.e. between barrel 20 and intermediate wheel 25.

In the duplex toothings described here, it is convenient and advantageous to make the two toothed rings in the form of distinct parts, so as to cut their toothed profiles separately. The term “ring” used here does not necessarily designate a separate part: for example, FIG. 5 shows that toothed ring 23a of the barrel forms an integral part of drum 22, as usual, while the second toothed ring 23b is manufactured separately, then driven onto the drum. Of course, the second ring has to be positioned in a precise angular position relative to the first ring by suitable jointing means or using external gauges during assembly.

In intermediate pinion 24, the top toothed ring 24a forms an integral part of arbour 26 and is machined directly thereto, whereas bottom toothed ring 24b is a part that is added on, separately machined and then driven onto the arbour. However, intermediate wheel 27 is made by superposing two similar plates whose rims form toothed rings 27a and 27b. These two wheels may be driven onto arbour 26, either one after the other, or together after having been pre-assembled to give the desired mutual phase difference. A similar construction is provided for centre wheel set 31. If necessary, the two superposed wheels forming a duplex toothing could be fitted with a fine phase difference adjustment device.

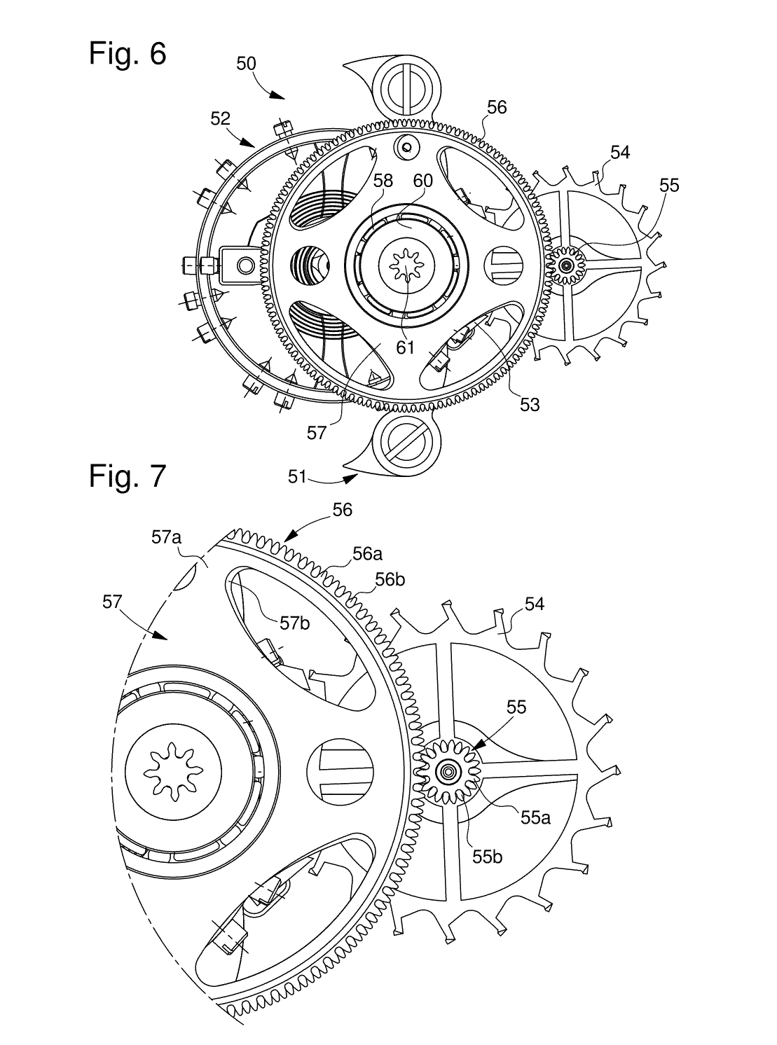

FIGS. 6 and 7 illustrate implementation of the invention in a timepiece movement with a rotating escapement, in this case a tourbillon 50. The carriage 51 of tourbillon 50, which is of the fly-wheel type and completes one revolution per minute, carries, as usual, an oscillator 52 with a balance and mainspring and an escapement including a lever 53 and an escape wheel 54, secured to an escape pinion 55. In the drawings, the bridge carrying the pivot of pinion 55 is omitted for the sake of clarity. This pinion meshes with toothing 56 of a stationary wheel 57, which carries, via a ball bearing 58, the single pivot 60 of carriage 51. As usual, pivot 60 is provided with the tourbillon drive pinion 61, driven by the going train.

As is shown in more detail in FIG. 7, the toothing of escape pinion 55 and toothing 56 of stationary wheel 57 are of the duplex type described above, each of the toothings being formed of a pair of toothed rings 55a and 55b, 56a and 56b, phase shifted by a half-pitch of a toothing relative to each other. Ring 55b of pinion 55 may be made in the usual way on the arbour of the escape wheel set, whereas ring 55a is preferably formed by a separate part, driven onto the arbour. However, stationary wheel 57 is formed in this example by assembling two superposed rings, including respective plates 57a and 57b and the respective toothed rings 56a and 56b. The precise angular shift between the two toothed rings is maintained by at least one pin (not shown) engaged in holes bored with a high level of precision in plates 57a and 57b.

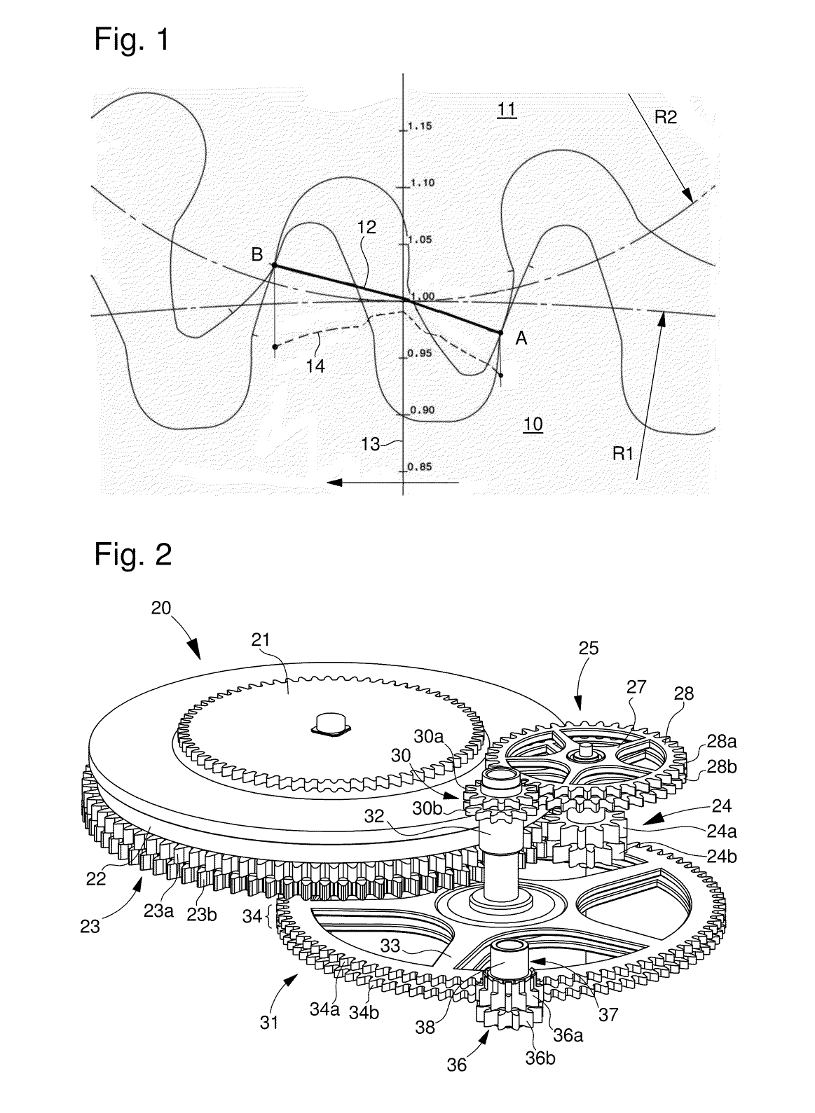

The use of multiple toothings, particularly duplex toothings, in a rotating escapement and especially a tourbillon, has the general advantages explained above as well as other, specific advantages. The radial play of tourbillon carriage 51, which is of the order of a hundredth of a millimetre, offers escape pinion 55 some freedom of radial movement relative to stationary toothing 56. Any centring defect of the carriage or escape wheel set further increases this movement. Any resulting torque or velocity variations directly affect the uniformity of the energy transmitted by the escape wheel to the oscillator via each impulse. If the escape pinion ordinarily has only 11 teeth, while escape wheel 54 has 20, it is clear that the impulses given by two successive teeth of wheel 54 correspond to two quite different positions of the same tooth of the pinion and may thus differ considerably because of the torque variations explained with reference to FIG. 1. It should be recalled that these variations are more marked in the end parts of path of contact 12, close to points A and B in FIG. 1. By removing these ends parts, the use of multiple teeth greatly reduces impulse energy variations in the tourbillon. Another advantage of the invention in this application is due to the very small diameter of escape pinion 55 with 11 teeth, meshing on the large stationary wheel 57 with 99 teeth. Given the operating conditions of a watch, these dimensions are at the limit of what can be achieved mechanically. The use of duplex toothings improves operation as much as if the number of teeth were doubled, with practically no concessions from the point of view of design.

The second embodiment illustrated by FIGS. 6 and 7 may be completed by the use of multiple toothings (especially duplex toothings) on tourbillon drive pinion 61 and on the wheel that drives it, with the effect of regularising the torque applied to the tourbillon by the mainspring. The invention can be used in accordance with the same principle in both of the gear connections of a carrousel type rotating escapement. Further, the embodiment described here can evidently be combined with the first embodiment, for example, in the form illustrated in FIGS. 2 to 5 or in a simpler form.

It will be noted finally that the wheels forming the duplex toothing may advantageously be made, for example in a single part, of silicon and/or metal by conventional photolithography and etching techniques and/or in combination with the LIGA technique. It will be noted that, in addition to allowing precise and easy manufacture, making these duplex wheels in a single piece also provides perfect indexing between the two toothings.

What is claimed:

1. A timepiece train including at least one pair of circular toothed elements with parallel axes, said toothed elements being provided with respective toothings that mesh with each other, wherein said toothings of each of the two toothed elements are multiple, each of said toothings comprising N coaxial, toothed rings angularly shifted relative to each other by a fraction of a pitch of the toothing.

2. The timepiece train according to claim 1, wherein each of said toothings is double, the two toothed rings being angularly shifted by a half-pitch.

3. The timepiece train according to claim 2, wherein the double toothing of a toothed element in the form of a pinion includes a first toothed ring forming an integral part of an arbour of the toothed element and a second toothed ring formed by an added part.

4. The timepiece train according to claim 2, wherein a toothed element in the form of a wheel with a double toothing is formed by superposing two similar plates, provided with said toothed rings.

5. The timepiece train according to claim 2, wherein the double toothing or a toothed element in the form of a barrel includes a first toothed ring forming an integral part of a drum of the barrel and a second toothed ring formed by an added part.

6. The timepiece train according to claim 1, wherein one of the pairs of toothed elements includes the escape pinion of a tourbillon and the stationary wheel of said tourbillon.

7. The timepiece train according to claim 6, wherein another one of the pairs of toothed elements includes the drive pinion of the tourbillon carriage.
